(19) United States
(12) Patent Application Publication
(10) Pub. No.: US 2002/0161638 A1
(43) Pub. Date: Oct. 31, 2002

(54) Virtual mall apparatus, method for performing discount service in virtual mall and program thereof

(76) Inventor: Masahide Ogawa, Shizuoka-ken (JP)

Correspondence Address: PILLSBURY WINTHROP, LLP, P.O. BOX 10500, MCLEAN, VA, 22102, US

(21) Appl. No.: 10/092,722

(22) Filed: Mar. 8, 2002

(30) Foreign Application Priority Data
Apr. 18, 2001 (JP) JP 2001-119683

(51) Int. Cl. G06F 17/60

(52) U.S. Cl. 705/14; 705/27

(57) ABSTRACT

A virtual mall includes a plurality of shops, virtually constructed by a virtual mall apparatus, to which a purchaser accesses and can buy items sold at each shop at a one-time shopping. A discount service is applied to the purchaser when the purchaser buys different items from at least two shops in the virtual mall.

### BACKGROUND OF THE INVENTION

1. Field of the Invention

This invention relates, in general, to virtual mall apparatus which realize a virtual mall (virtual shopping mall) including a plurality of virtual shops. For example, such virtual mall is constructed on information networks such as Internet. In particular, the invention relates to services performed in the virtual mall to promote frequent access to the virtual mall by purchasers.

2. Description of the Related Art

In recent years, on-line shopping system as shown in Japanese Patent Application (KOKAI) Publication No.2000-163480 is put into a practical use. In such on-line shopping system, a virtual mall that comprises a plurality of virtual on-line shops on the Internet is realized and a customer or a purchaser accesses to the virtual mall through a terminal such as a personal computer or a cellular phone to buy items sold in each virtual on-line shop therein.

In more detail, a customer operates first the terminal in which the WWW (World-Wide Web) browser has been installed, and accesses to the virtual mall site on the Internet. Then, an image formed in the HTML (Hyper Text Markup Language) file format which introduces a virtual mall is downloaded to the terminal. The image is interpreted by the WWW browser and is displayed on the display part of the terminal. Next, the customer further operates the terminal to access to one of the virtual on-line shops of the virtual mall. Then, an image in the HTML file format which introduces items sold in this virtual on-line shop is downloaded and displayed on the terminal. When items to be purchased are found, the customer buys the items through the terminal.

In this way, the customer accesses to virtual online shops one by one and she or he buys items each time if there are items to be purchased. When the purchase command is input through the terminal, an item list that the customer bought is downloaded and displayed on the terminal. After checking the item list, the customer input a method of payment through the terminal. When the method of payment input is verified and accepted by the virtual mall site, the dealing or shopping is completed. After that, the items to be purchased are notified to corresponding shop owners who run virtual on-line shops from the administrator who operates a virtual mall site, and the items are delivered from each shop owner to the customer through a known delivery system. At last, payment for the items is settled between the customer and the administrator by the accepted method of payment and the payment between the administrator and each shop owner is also settled in a predetermined manner.

In the meantime, at stores which actually exist such as a supermarket, a discount sales method called M&M (mix-and-match) has been practiced to gather customers. In this discount sales method, a fixed percentage discount is made or a fixed amount is taken from the total amount to be paid when a customer buys a plurality of items which are specified as an M&M discount item beforehand.

For example, when chocolates and caramels are specified as an M&M discount item, each item is sold at a ten (10) percent discount from a prescribed sales price when both items of chocolate and caramel are bought at a one-time shopping although each item is sold at a prescribed sales price when a single item of either chocolate or caramel is purchased even if more than one piece of the single item are bought.

Therefore, it has been considered also in a virtual mall that an incentive sales method similar to the above-described M&M discount is adopted to increase sales amount. In a virtual mall, it is possible that a purchaser may visit a plurality of virtual on-line shops in one-time shopping and buy items at each shop. Moreover, from the viewpoint of the administrator of a virtual mall, it is preferable that each sales amount of all shops in the mall is increased by dispersing purchasers to each shop rather than that the sales amount of a particular virtual shop is projected by concentrating purchasers on that shop.

### SUMMARY OF THE INVENTION

Accordingly, it is an object of the present invention to promote frequent access to a virtual mall by purchasers.

It is another object of the invention to provide a new incentive service to a purchaser in a virtual mall.

It is still another object of the present invention to provide a virtual mall apparatus which realizes a new incentive service in a virtual mall.

To accomplish the above-described objects, a virtual mall apparatus includes means for producing a purchased item data when a purchase command indicating that a purchaser buys an item at one of a plurality of virtual shops is input, means for checking a plurality of purchased item data of the purchaser whether items are purchased at least two different virtual shops, and means for applying an incentive service to the purchaser when the items are purchased from at least two different virtual shops.

### BRIEF DESCRIPTION OF THE DRAWINGS

The present invention will be described with reference to the accompanying drawings, in which:

FIG. 1 is a block diagram showing construction of on-line shopping system including one embodiment of a virtual mall apparatus of the present invention;

FIG. 2 is a schematic view showing the data structure of an item file shown in FIG. 1;

FIG. 3 is a schematic view showing the data structure of an M&M file shown in FIG. 1;

FIG. 4 is a block diagram showing hardware construction of a mall server in FIG. 1;

FIG. 5 is a schematic view of the main memory area of a RAM in FIG. 4;

FIG. 6 is a flow chart showing procedures of a main process which CPU shown in FIG. 4 performs;

FIG. 7 is also a flow chart showing procedures of a main process which CPU in FIG. 4 performs in succession to the procedures shown in FIG. 6;

FIG. 8 is a flow chart showing one of the M&M judging methods in FIG. 7;

FIG. 9 is a schematic view showing an example of the layout of a homepage image on a display screen of one embodiment of the invention;

FIG. 10 is a schematic view of an example of the layout of an M&M discount item list image on the display screen of one embodiment of the invention;

FIG. 11 is a schematic view of an example of the layout of a store item introductory image on the display screen of one embodiment of the present invention;

FIG. 12 is a schematic view of an example of the layout of a purchased item image on the display screen of one embodiment of the present invention;

FIG. 13 is a schematic view of an example of the layout of a purchased item list image on the display screen of one embodiment of the present invention; and

FIG. 14 is a schematic view of another example of the layout of purchased item list image on the display screen of one embodiment of the invention.

### DETAILED DESCRIPTION OF THE PREFERRED EMBODIMENT

Preferred embodiment of the present invention will now be described in more detail with reference to the accompanying drawings. In the drawings, the same numerals are applied to similar elements and thus, description thereof are not repeated.

This embodiment discloses a virtual mall apparatus which realizes a virtual mall wherein a specific incentive service, e.g., discount service, (referred to as a wide-range M&M) is applied when a purchaser buys different items, which are specified as a wide-range M&M item, at a plurality of virtual on-line shops, respectively.

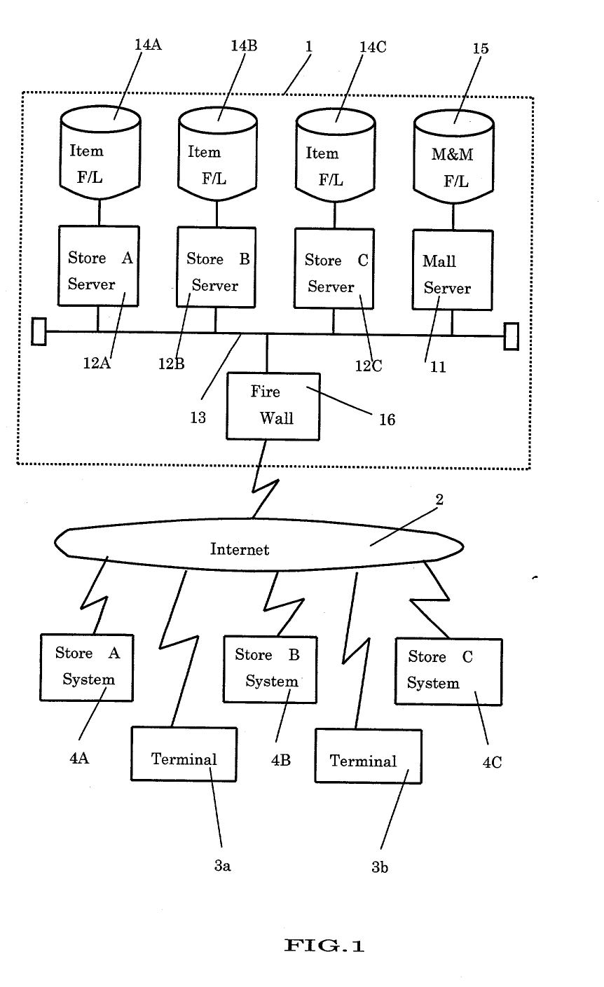

FIG. 1 is a block diagram of the construction of an on-line shopping system containing one embodiment of a virtual mall apparatus 1. In the shopping system, a virtual mall apparatus 1 which comprises a plurality of virtual on-line shops A, B and C on an information network such as Internet 2 is connected to the Internet 2. The virtual mall apparatus 1 executes a shopping-transaction between each virtual on-line shop and a purchaser when a purchased item data of one of the plurality of shops A, B or C is input to the virtual mall apparatus 1.

The virtual mall apparatus 1 includes a mall server 11 and store servers 12A, 12B and 12C corresponding to the plurality of virtual shops A, B and C, respectively. The mall server 11 and store servers 12A, 12B and 12C are connected through the LAN (Local Area Network). The mall server 11 controls and operates the virtual mall, and store servers 12A, 12B and 12C manage items sold in the corresponding virtual shops A, B and C, respectively.

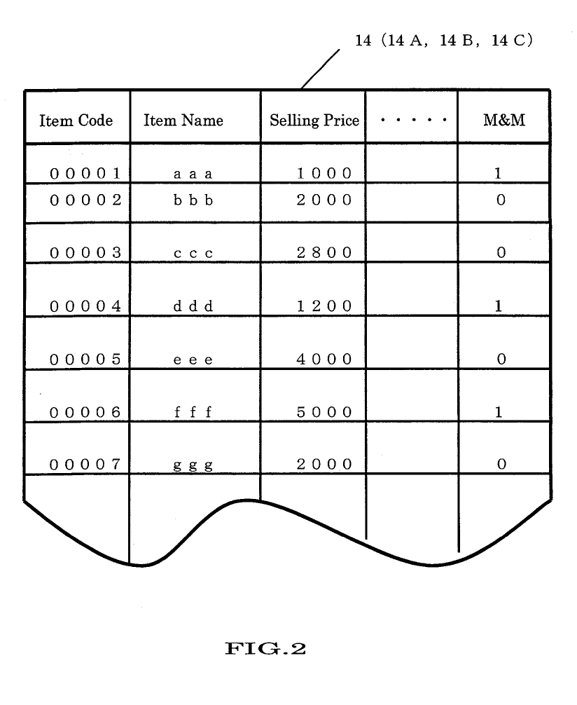

Store servers 12A, 12B and 12C include, as a database, item files 14A, 14B and 14C correspondingly. As shown in FIG. 2, item files 14A, 14B and 14C store therein set data, including an item code, item name corresponding to the item code and its selling price. The item code identifies each item sold in each virtual on-line shop. In particular, the set data also includes an M&M item flag which is set at “1” when the corresponding item is specified as a wide-range M&M item and is reset at “0” otherwise.

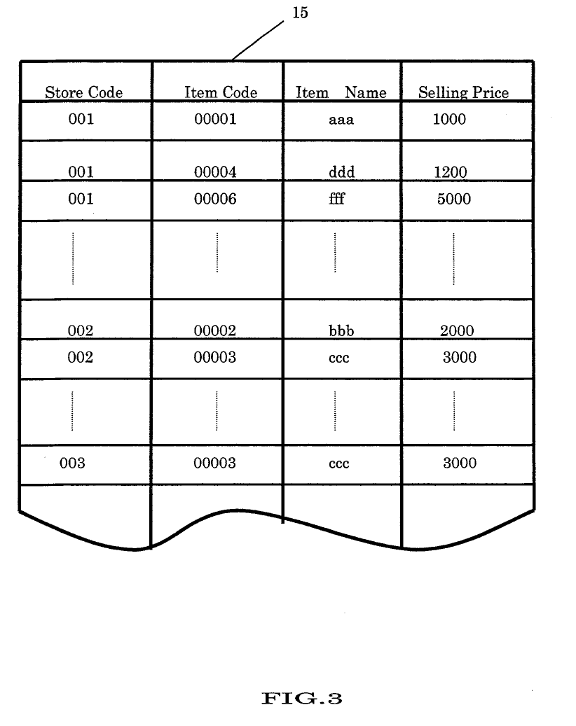

The mall server 11 includes a wide-range M&M file 15 as a database. As shown in FIG. 3, this M&M file 15 stores therein a series of data including a store code, an item code, an item name and its selling price. In this case, the store code identifies each virtual on-line shop A, B and C and the item code identifies an item which is specified as a wide-range M&M item at the shop identified by the store code.

Moreover, as can be seen in FIG. 1, virtual mall apparatus 1 includes a server 16, acting as a fire wall, which is placed at an interface portion between the LAN13 and the Internet 2 to maintain security against access from the outside.

A plurality of terminals 3a and 3b, such as personal computers, in each of which the WWW browser is installed are connected to Internet 2. Each terminal 3a, 3b is operated by user to access to the virtual mall on Internet 2.

Moreover, a plurality of store systems 4A, 4B, and 4C each of which is composed of a computer are also connected to Internet 2 and are operated by the corresponding shop owners who own virtual on-line shops, A, B and C respectively. Virtual on-line shop owners can modify (delete, add or change) the data of item files 14A, 14B and 14C of store servers 12A, 12B and 12C of the virtual mall apparatus 1 through the corresponding store systems 4A, 4B, and 4C, respectively. The shop owners also can control through the corresponding store systems 4A, 4B and 4C delivery of the items which are noticed as a purchased item from the virtual mall apparatus 1.

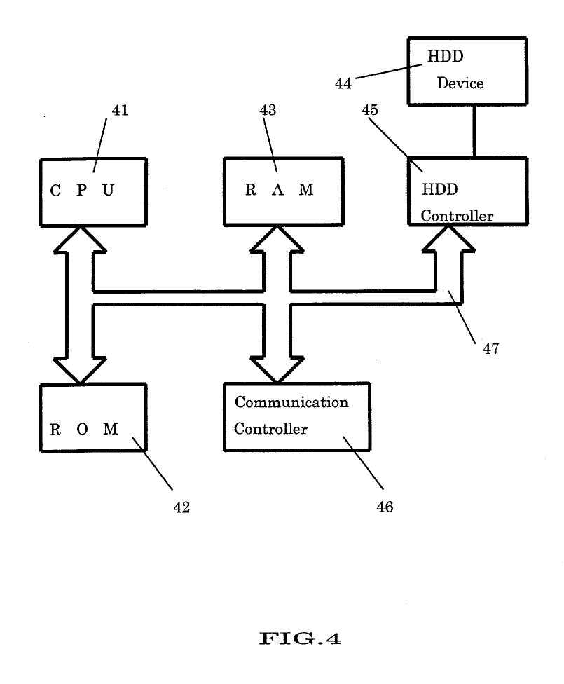

FIG. 4 is a block diagram showing the hardware construction of the mall server 11. The mall server 11 includes a CPU (Central Processing Unit) 41 as a main controller, a ROM (Read Only Memory) 42 in which a fixed data such as a control program is stored, a RAM (Random Access Memory) 43 in which memory areas are formed to temporally store various data. The mall server 11 also includes an HDD (Hard Disk Drive) device 44 which stores the above-mentioned M&M file 15, an HDD controller 45 which drives the HDD device 44 and a communication controller 46 which controls data communication with other servers connected through the above-mentioned LAN 13. And CPU 41, ROM 42, RAM 43, HDD controller 45 and communication controller 46 are connected with the bus lines 47, such as an address bus and a data bus.

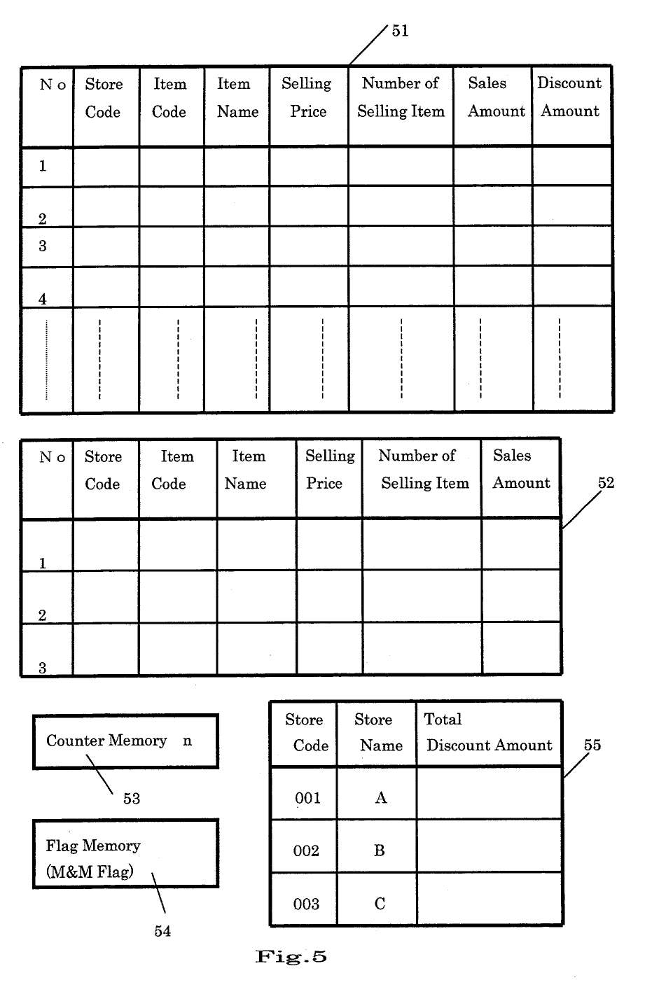

As shown in FIG. 5, the RAM 43 of the mall server 11 includes a purchased item information table 51, an M&M judging table 52, a counter memory 53, a flag memory 54 (M&M flag) at which “1” is set when the condition of the wide-range M&M is satisfied and a store memory 55 which stores a store code for identifying virtual on-line shops A, B and C, a store name and a total discount amount of the shop identified by the store code.

The purchased item information table 51 stores a purchased item information composed of a store code, an item code, an item name, a selling price, number of selling item, a sales amount and a discount amount.

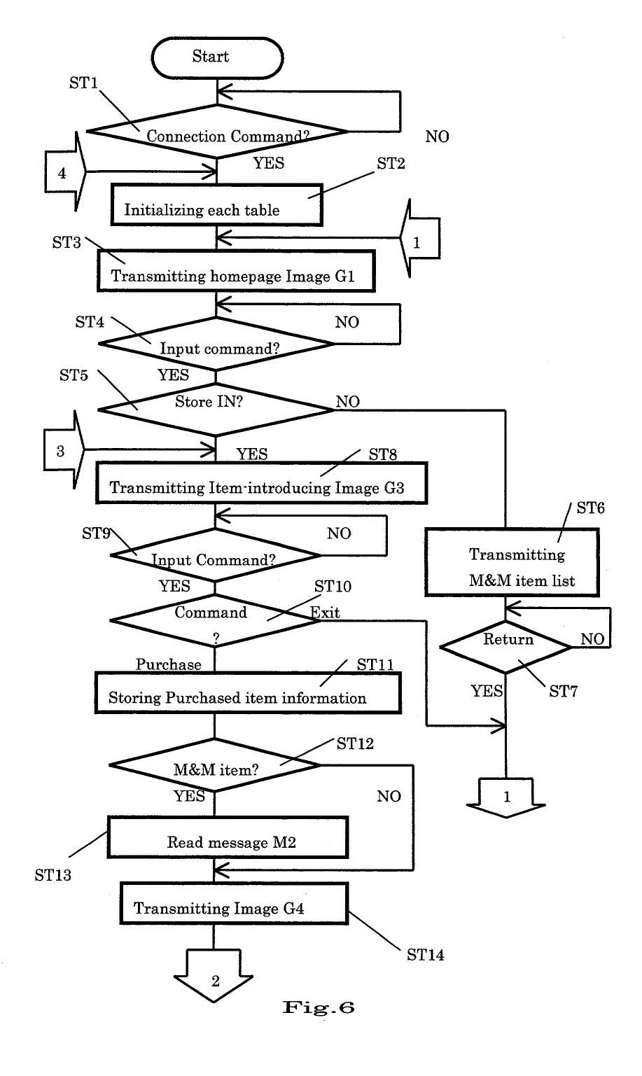

The M&M judging table 52 stores a purchased wide-range M&M item information including a store code, an item name, a selling price, number of selling item and a sales amount. Moreover, the program stored in ROM 42 is constituted so that CPU 41 performs processes shown in flowcharts of FIGS. 6,7 and 8.

In FIG. 6, CPU 41 maintains its standby states until receiving a connection command from a purchaser through the terminal 3a, for example (step 1). Purchaser connects the terminal 3a to Internet 2 and inputs URL (Uniform Resource Locator) of a virtual mall into the terminal 3a.

When the connection command is input to the virtual mall apparatus 1 through the server 16 acting as a firewall, CPU 41 initializes the purchased item information table 51 and the M&M judging table 52 of RAM 43 to clear the contents of tables 51 and 52 in step 2.

In step 3, CPU 41 transmits a home page image G1 of HTML file format which introduces the virtual mall to the terminal 3a from which the connection command is input through Internet 2. Thus, the home page image G1 interpreted by the WWW browser is displayed on the display screen of the terminal 3a.

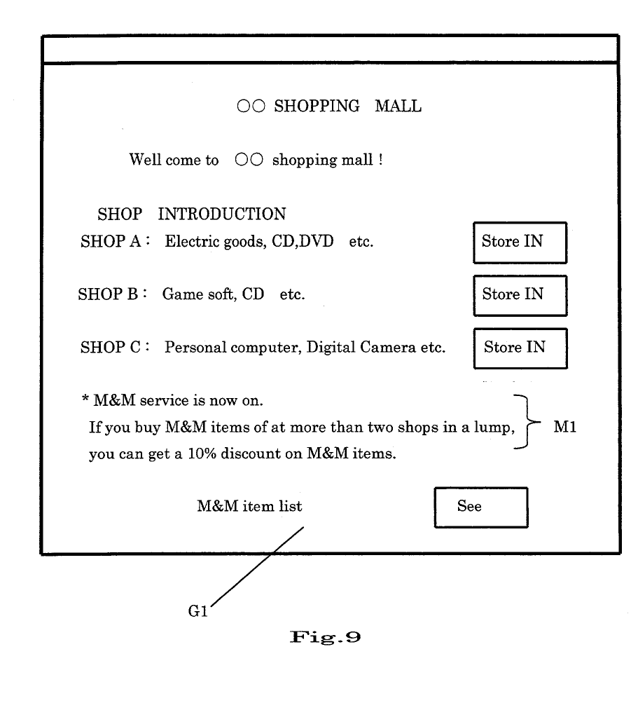

As shown in FIG. 9, the home page image G1 on the display of the terminal 3a includes store names of the virtual on-line shops participating the virtual mall and text data of items sold in each shop respectively. The home page image G1 also includes a plurality of input buttons [Store IN] which correspond to the number of shops. When one of the plurality of buttons [Store IN] is clicked, an entering command is produced. Thus, the purchaser can enter the shop corresponding to the button clicked and can see items sold in the shop.

Moreover, a message M1 and an input button [See] is displayed on the display of the terminal 3a. The message M1 notifies the purchaser of the contents of the incentive service, e.g., wide-range M&M service, which now carries on. When the input button [See] is clicked, a wide-range M&M item display command is produced. Thus, the M&M item list is displayed on the terminal 3a and the purchaser can see the items specified as a wide-range M&M item at each shop in the virtual mall, respectively.

As shown in FIG. 4, in step 4, CPU 41 waits until the entering command or the display command is input from the terminal 3a to which the home page image G1 is transmitted.

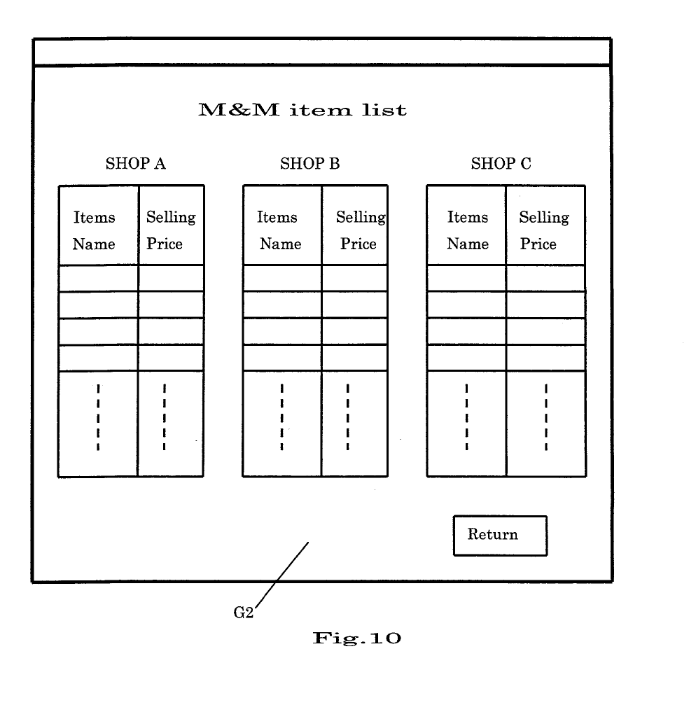

In step 5, a command is discriminated when the command produced by clicking buttons [Store IN] or [See] is received. If the command is produced by clicking the button [See], CPU 41 produces an item list image G2 in which items specified as a wide-range M&M item by virtual on-line shops A, B and C are listed based on the data stored in the M&M file 15 (step 6). And thus, the item list image G2 is transmitted through Internet 2 to the terminal 3a from which the command is sent. Thereby, the item list image G2 is displayed on the terminal 3a. As is shown in FIG. 10, in the item list image G2, item names and selling prices thoseof, which are specified as a wide-range M&M item by each shops A, B and C, are classified by shop.

An input button [Return] is also displayed on the terminal 3a. When the button [Return] is clicked, the display on the terminal 3a is changed from the present image G2 to the former image G1. Thus, the purchaser clicks the button [Return] after she or he identifies wide-range M&M items from the item list image G2 on the terminal 3a. Thus, CPU 41 is in a standby states until the button [Return] is clicked in step 7. CPU 41 returns to step 3 and then transmits the image G1 to the terminal 3a through Internet 2 when the mall server 11 receives the return command input by clicking the button [Return].

In step 5, if the purchaser clicks the button [Store IN] corresponding to the shop A of the image G1 on the display of the terminal 3a, CPU 41 receives the entering command from the terminal 3a and identifies that the purchaser wants to enter the shop A. In step 8, CPU 41 produces an item-introducing image G3 based on the item file 14A controlled by store server 12A and transmits the image G3 to the terminal 3a. The item-introducing image G3 introduces items sold in the virtual on-line shop A that the purchaser wants to enter.

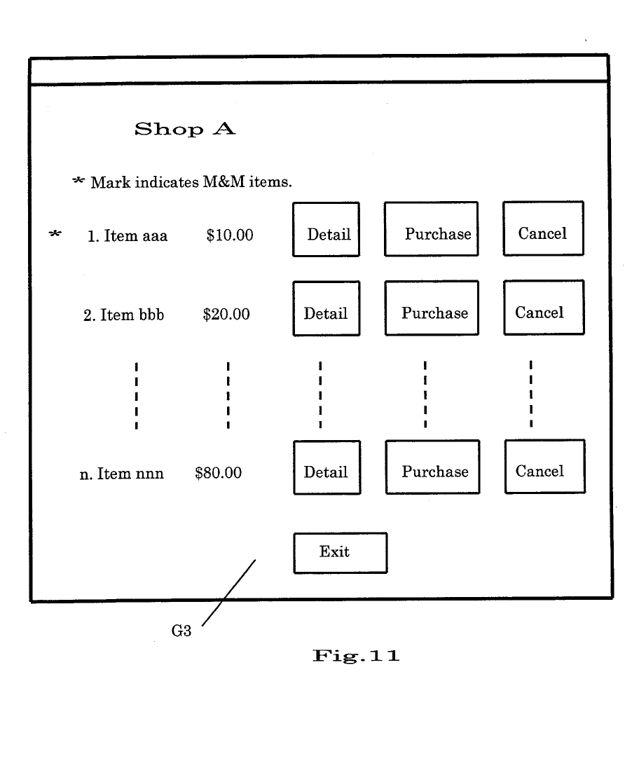

As shown in FIG. 11, the image G3 is displayed on the terminal 3a. The image G3 includes an item name and corresponding selling price in a row. The image G3 also includes input buttons [Detail], [Purchase] and [Cancel] in the same row. A plurality of rows including item name, selling price and input buttons [Detail], [Purchase] and [Cancel] are provided in the image G3. In addition, an input button [Exit] is provided at the bottom of the rows.

If the input button [Detail] is clicked, a detail information command is produced to request detail information of the item corresponding to the button [Detail] clicked. If the input button [Purchase] is clicked, a purchase command is produced to buy the item corresponding to the button [Purchase] clicked. Also, if the input button [Cancel] is clicked after the button [Purchase] is once clicked, a cancel command is produced to cancel purchase of the item corresponding to the button [Cancel] clicked. If the button [Exit] is clicked, an exit command is produced to go out of the shop A.

As can be seen in FIG. 11, a mark “*” is provided at the head of the first row to indicate that this item is specified as a wide-range M&M item.

In step 9 of FIG. 6, CPU 41 is in a standby states until a command is input from the terminal 3a. If a command produced by clicking one of the input buttons [Detail], [Purchase], [Cancel] and [Exit] is received, the CPU 41 interprets the command in step 10. If the exit command is received, the step 3 is executed. The home page image G1 is transmitted to the terminal 3a through Internet 2.

If the purchase command of the item aaa is received from the terminal 3a, CPU 41 produces a purchase information data and stores the data in the purchased item information table 51 of RAM 43. The purchase information data includes a store code corresponding to the shop A, an item code corresponding to the item aaa purchased and an item name aaa. The purchase information data also includes a selling price of the item aaa, number of item purchased: 1 (default value), a sales amount (selling price X number of item) and a discount amount: 0 (default value).

In step 12, CPU 41 discriminates whether the purchased item is the wide-range M&M item or not based on the M&M item flag of the set data of the item to be purchased stored in the item file 14A. If the item is determined as an M&M item, CPU 41 reads out a message M2 notifying the purchaser that the item to be purchased is M&M item in step 13. In step 14, CPU produces an item purchase image G4 and sends the image G4 to the terminal 3a.

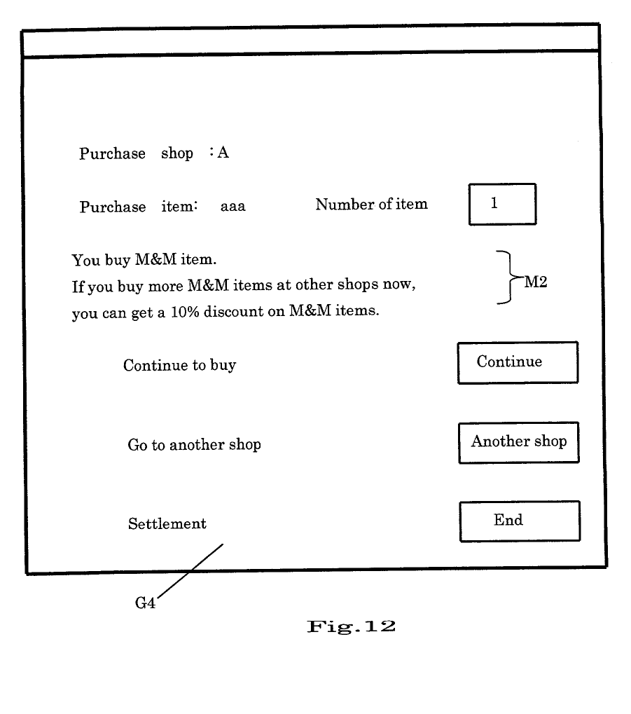

As shown in FIG. 12, the item purchase image G4 includes the shop name A, the item name aaa and the number of item to be purchased. Number of item to be purchased can be changed by the terminal 3a. The image G4 also includes the message M2 if the message M2 is read out in step 13. The image G4 further includes three buttons [Continue], [Another shop] and [End]. If the button [Continue] is clicked, a purchase-continue command is produced to continue purchase of another items at the same shop. If the button [Another shop] is clicked, a move command is generated to move to another virtual on-line shop. If the button [End] is clicked, a settlement command is produced to pay for the item aaa which is bought in this shop A.

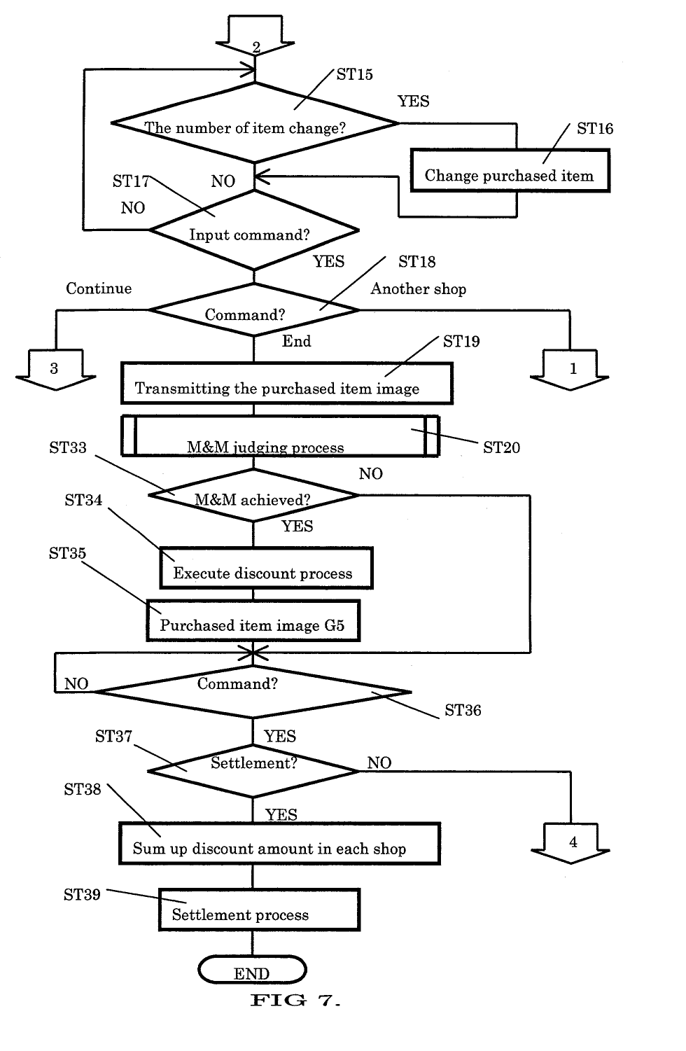

In step 15 of FIG. 7, CPU 41 is in standby states until the number of item on the image G4 is changed from the terminal 3a. If the number of item is changed, the number of item of the purchase information data stored in the purchased item information table 51 is changed to new one inputted and the selling amount of the data is also changed (step 16).

On the other hand, CPU 41 is also in standby states until one of the buttons [Continue], [Another shop] and [End] is clicked (step 17). If a command is received, CPU 41 determines which of the buttons is clicked (step 18).

If the purchase-continue command produced by clicking the button [Continue] is received, step 8 is executed. Then, the item-introducing image G3 is transmitted to the terminal 3a through Internet 2. The item-introducing image G3 is displayed on the terminal 3a and the purchaser can buy another items at the same shop A or cancel the purchased item aaa by clicking the corresponding button [Purchase] or [Cancel] on the image G3.

If the move command generated by clicking the button [Another shop] is received in step 18, step 3 is executed. The home page image G1 is transmitted to the terminal 3a and thus, the image G1 is displayed on the terminal 3a. The purchaser can enter another virtual on-line shop B or C or can see the M&M item list by clicking the corresponding button [Store IN] or [See] on the image G1.

If the settlement command produced by clicking the button [End] on image G4 is received in step 18, a purchased item image (not shown) is produced based on the purchased item information stored in the purchased item information table 51. The purchased item image includes shop names at which the purchaser bought items, item names, number of items and each selling price. Then, the purchased item image is transmitted to the terminal 3a through Internet 2 (step 19).

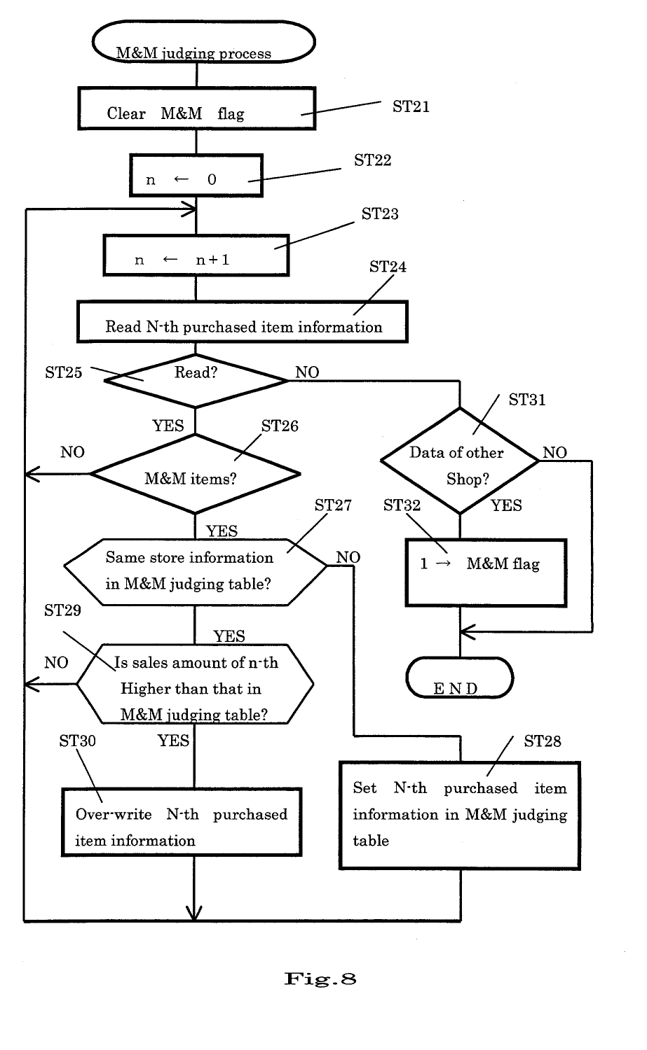

As shown in FIGS. 7 and 8, an M&M judging process is executed. In step 21 of FIG. 8, M&M flag 54 is cleared to zero. The content (n) of counter memory 53 is also cleared to zero (step 22).

In step 23, one is added to the content (n) of the counter memory 53. In step 24, n-th purchased item information is read out of the purchased item information table 51 by referring the content (n) of the counter memory 53. If n-th purchased item information can be read out in step 25, the M&M file 15 is retrieved by referring the store code and the item code of n-th purchased item information to determine whether the same store code and item code are registered in the M&M file 15. If such store code and item code are not found in the M&M file 15, step 23 is executed to increase the content (n) of the counter memory 53. The purchased item specified by n-th purchased item information is not wide-range M&M item.

If the store code and item code of n-th purchased item information are found in M&M file 15, it is determined that the purchased item specified by n-th purchased item information is M&M item. Then, in step 27, CPU 41 checks whether the same store code and item code of n-th purchased item information are found in M&M judging table 52. If such store code and item code are not found in M&M judging table 52, the store code, the item code, the item name, its selling price, the number of item and its sales amount of n-th purchased item information are stored in M&M judging table 52. After that, the content (n) of the counter memory 53 is increased by 1 in step 23.

On the other hand, if purchased item data including a store code same as that of n-th purchased item information is found in the M&M judging table 52, the sales amount of the purchased item data in the M&M judging table 52 is compared with the sales amount of n-th purchased item information in step 29. As a result of the comparison, when the sales amount of n-the purchased item information is higher than that of the purchased item data in the M&M judging table 52, the item code, the item name, the selling price, the number of item and the sales amount of the purchased item data in M&M judging table 52 are over-written with those of n-th purchased item information to renew the data in M&M judging table 52 in step 30. After that, the content (n) of the counter memory 53 is increased by 1 in step 23. When the sales amount of n-the purchased item information is equal to or lower than that of the purchased item data in M&M judging table 52, step 30 is not executed.

In like manner, step 26 to step 30 are executed every time CPU 41 reads out n-th purchased item information from the purchased item information table 51 by referring the content (n) of the counter memory 53. If data of n-th purchased item information is not stored and thus CPU 41 can not read out the data in step 25, step 31 is executed. In step 31, it is determined whether the purchased item data of other virtual on-line shop is stored.

When purchased item data of other virtual on-line shop is stored in M&M judging table 52, “1” is set in the flag memory 54 (M&M flag). This is because that M&M items are bought over the plurality of shops and thus the wide-range M&M is achieved. On the contrary, if purchased item data of other virtual on-line shop is not stored in M&M judging table 52, the flag. memory 54 (M&M flag) is not changed. Then, above-described M&M judging process is completed.

As shown in FIG. 7, CPU 41 checks the content (M&M flag) of the flag memory 54 in step 33. If the content of flag memory 54 is “0”, steps 34 and 35 are not executed. Because, wide-range M&M is not achieved at the present shopping by the purchaser.

If the content (M&M flag) of the flag memory 54 is “1”, step 34 is executed to carry out an incentive service, e.g., a discount process. In detail, data in the purchased item information table 51 whose store code and item code coincide with those of each data stored in M&M judging table 51 is identified. When such data is identified, a discount amount is calculated by multiplying the selling price of the data identified by a constant discount rate, e.g., 10%. The discount amount is subtracted from the selling price of the data to seek the discounted selling price. In addition, the sales amount of the data identified is re-calculated based on the discounted selling price. The above-described steps are repeated until data in the purchased item information table 51 whose store code and item code coincide with those of each data stored in M&M judging table 51 goes to zero. Thus, the discount service is effected to data stored in the purchased item information table 51 and data in the table 51 are renewed.

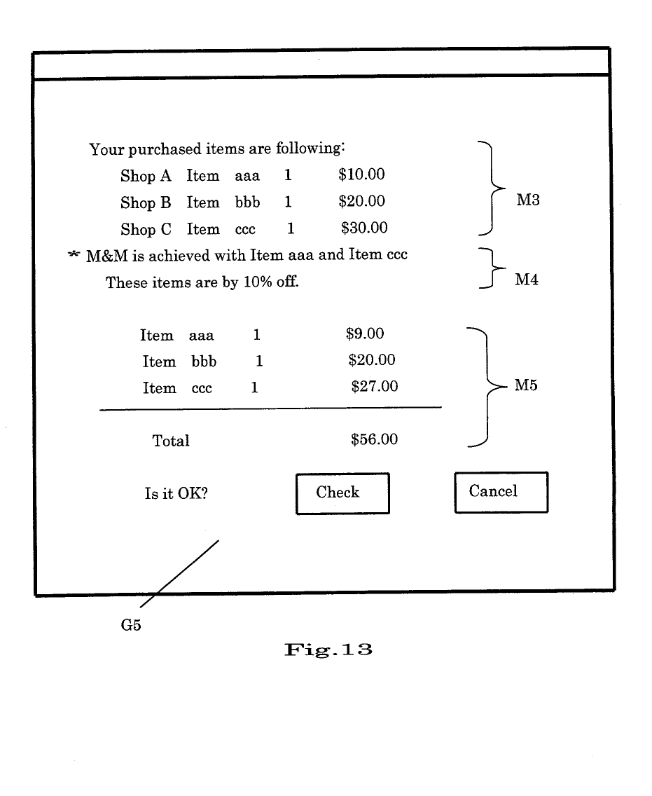

In step 35, a purchased item image G5 is produced based on the latest purchased item information table 51 and is sent to the terminal 3a through Internet 2 to show the image G5 on the terminal 3a, as shown in FIG. 13.

The purchased item image G5 includes a plurality of first rows M3. Each row includes shop name at which the purchaser bought items, item name purchased, number of items and its sales amount. The image G5 also includes a message M4 which indicates the item names that the wide-range M&M is achieved and the contents of the discount service. The image includes a plurality of second rows M5 each of which contains item name, e.g., aaa that the wide-range M&M is achieved and its discounted selling price $9.00. The second rows M5 also include item name bbb that is not M&M item and its selling price $20.00 and item name ccc that the wide-range M&M is achieved and its discounted selling price $27.00. The bottom of the second rows M5 indicates total sales amount $56.00.

The purchased item image G5 further includes a plurality of buttons [OK] and [Cancel]. The button [OK] indicates that the purchaser confirms the contents of purchased item image G5 and a settlement command is produced when the button [OK] is clicked. The button [Cancel] indicates that the purchaser cancels purchase of the items indicated in the image G5 and a cancel command is generated when the button [Cancel] is clicked.

On the other hand, the purchased item image G5 does not include the message M4 and the plurality of second rows M5 when the wide-range M&M is not achieved and thus no such message M4 and second rows M5 are displayed but the plurality of first rows M3 and total sales amount is displayed on the terminal 3a.

In step 36 of FIG. 7, CPU 41 is in standby states until button [OK] or [Cancel] on the purchased item image G5 is clicked. If the cancel command is received in step 37, step 2 is executed. The purchased item information table 51 and the M&M judging table 52 are cleared and the home page image G1 is again transmitted to the terminal 3a. Thus, the purchaser can re-commence on-line shopping at this virtual mall or terminate on-line shopping.

In step 37, if the settlement command is received, discount amount of each data stored in the purchased item information table 51 is added to the discount amount data of one of the shops of the store memory 55 which corresponds to the store code of the data stored in the purchased item information table 51 to sum up each added result in step 38. After that, a settlement process is executed in step 39 and the communication between the virtual mall and the purchaser is disconnected.

The settlement process may be a known process. For example, a method of payment is requested to the purchaser and the method of payment input is verified. If the method of payment is verified and accepted, order sheets for the purchased items classified by shop are produced and are sent to store systems 4A, 4B and 4C, correspondingly through Internet 2.

The wide-range M&M discount service of the present invention will be described in more detail.

A customer purchases at a virtual on-line shop A an item aaa (selling price: $10.00) which is a wide-range M&M item of shop A, and further purchases at a virtual on-line shop B an item bbb (selling price: $20.00) and an item ccc (selling price: $30.00) which are wide-range M&M items of shop B. Since the customer buys item aaa from the shop A, items bbb and ccc from another shop B and items aaa, bbb and ccc are specified by shops A and B as a wide-range M&M item, the wide-range M&M is achieved. In this case, however, since the customer bought both items bbb and ccc at on-line shop B, the selling prices of items bbb and ccc are compared to specify which of the items bbb and ccc is combined with item aaa of shop A to achieve the wide-range M&M. As a result, item ccc of shop B is selected to combine with item aaa of shop A because the selling price of item ccc is higher than that of item bbb. Thus, selling prices of items aaa and ccc are discounted by 10% respectively, for example as shown in FIG. 13.

As described above, if a customer buys at one shop a plurality of items which are specified as a wide-range M&M item at the same shop, an item having a higher selling price is selected as a wide-range M&M item when the wide-range M&M is achieved. Thus, an advantageous discount for a customer can be performed. On the other hand, since all of the items which are M&M discount items are not always subject to discount even if the wide-range M&M is achieved, a large loss caused by the wide-range M&M service can not occur at one shop.

Another case of the wide-range M&M service will be described.

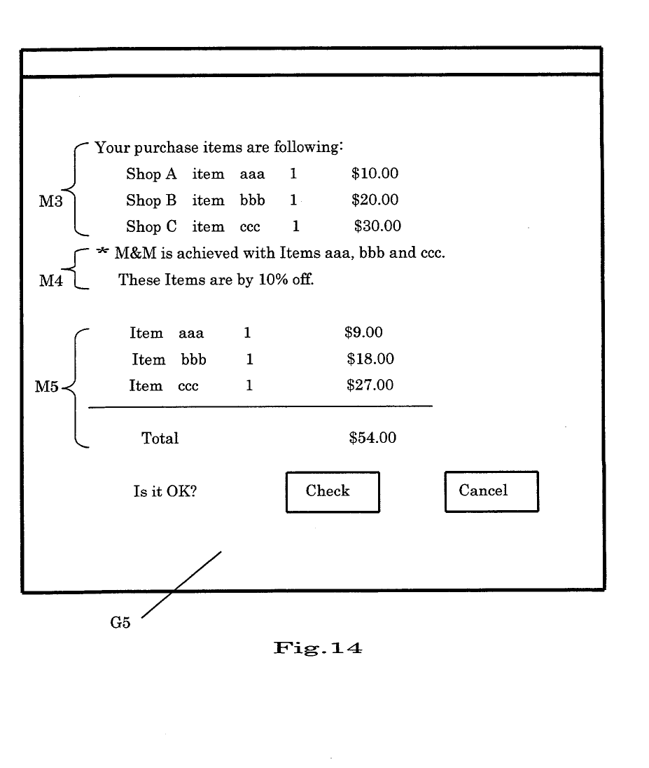

A customer buys at a virtual on-line shop A item aaa (selling price: $10.00) which is a wide-range M&M item of shop A, at shop B item bbb (selling price: $20.00) which is a wide-range M&M item of shop B and at shop C item ccc (selling price: $30.00) which is also a wide-range M&M item of shop C. In this case, since all of the items aaa, bbb and ccc which are wide-range M&M items and each item is bought at different shops A, B and C, respectively, the wide-range M&M is achieved and selling prices of the items aaa, bbb and ccc are discounted by 10%, for example, as shown in FIG. 14. Following processes are the same as those of the above-described one case.

As can be understood from the above-described embodiment, in a virtual shopping mall on Internet, since a discount service is applied to a customer who buys specific items (wide-range M&M items) at different virtual on-line shops, customers frequently visit the virtual shopping mall and thus it can be expected to increase a sales amount of each virtual on-line shop of the mall. In addition, since customers do not concentrate on a specific on-line shop but visit different on-line shops, increase in an average sales amount of all of the on-line shops can be expected.

In the above-described embodiment, a discount amount caused by the discount service is classified by shop and added up, discount amount for each shop can be correctly notified to the shop owner who owns corresponding virtual on-line shop. It is easy to change the charge of discount amount from shop owners to the mall administrator if the condition is changed.

In the embodiment, the wide-range M&M is achieved when a customer buys from on-line shops wide-range M&M items which are respectively specified by different on-line shops as a wide-range M&M item. However, it is possible to achieve a wide-range M&M if a customer buys items from different on-line shops at one-time on-line shopping where all of items sold at all of on-line shops of the mall are wide-range M&M items. In this case, M&M file 15 is not required and step 26 of wide-range M&M judging process shown in FIG. 8 is not required also. In more detail, when the [OK] button is clicked at the terminal 3a to generate the settlement command, it is checked whether the purchased items are bought from the plurality of virtual on-line shops based on the purchased item information stored in the purchased item information table 51. If each purchased item information of at least two shops are stored in the M&M judging table 52 and thus it is determined that the items are purchased from more than one virtual on-line shop. In this case, “1” is set in the M&M flag and the wide-range M&M is achieved.

In the above-described embodiment, discount service is applied to a customer when the wide-range M&M is achieved. However, other incentive services instead of discount service can be applied to the customer who achieves the wide-range M&M. Incentive services may be that special goods is provided to customer or doubled points are given to M&M items respectively which are bought by the purchaser at different shops in a specific point service system when the customer achieves the wide-range M&M.

The present invention is applied to the virtual shopping mall on the Internet in one embodiment. However, the invention can be applied to a stand-alone type virtual mall apparatus, within which a shopping system is constructed, installed in a shopping center.

The present invention has been described with respect to specific embodiments. However, other embodiments based on the principles of the present invention should be obvious to those of ordinary skill in the art. Such embodiments are intended to be covered by the claims.

What is claimed is:

1. A virtual mall apparatus which virtually constructs a virtual mall including a plurality of virtual shops, comprising:
means for producing a purchased item data when a purchase command indicating that a purchaser buys an item at one of the plurality of shops is input, the purchased item data including a store code indicating one of the virtual shops at which the item is purchased and an item code indicating the item purchased;
means for checking a plurality of purchased item data of the purchaser whether items are purchased from at least two different virtual shops based on the purchased item data; and
means for applying an incentive service to the purchaser if the items are purchased from at least two different virtual shops.

2. An apparatus according to claim 1, wherein the checking means includes means for discriminating whether at least two different store codes are included in the plurality of purchased item data.

3. An apparatus according to claim 1, wherein the checking means includes second means for discriminating whether at least two different item codes are included in the plurality of purchased item data, and third means for discriminating whether the store codes respectively identifying virtual shops which sell items identified by the at least two different item codes are coincided with one another if the second means determines that the at least two different item codes are included in the plurality of purchased item data, wherein it is determined that the at least two different items are bought at different shops when the third means determines that the store codes are not coincided with one another.

4. A virtual mall apparatus comprising:
means for virtually constructing a virtual mall including a plurality of virtual shops;
means for generating a purchased item data when a purchase command is input, the purchase command indicating that a purchaser buys an item at one of the plurality of shops, the purchased item data including a store code identifying one of the virtual shops at which the item is purchased, an item code identifying the item purchased and a discount item flag indicating that the purchased item is a discount item, the discount item flag being set where the purchased item is specified as a discount item by one of the plurality of shops;
means for discriminating whether items indicated by at least two discount item flags in a plurality of purchased item data are respectively purchased from different shops based on the purchased item data; and
means for executing a discount if the discriminating means determines that the items indicated by the at least two discount item flags are purchased from different shops.

5. An apparatus according to claim 4, wherein the discount is applied to items of different shops indicated by the at least two discount item flags, further including means for collecting each discount applied to the items classified by shop.

6. An apparatus according to claim 4 further including means for selecting one item from at least two different items indicated by at least two discount item flags if the at least two different items indicated by the at least two discount item flags are purchased at the same shop.

7. An apparatus according to claim 6, wherein each item of the at least two different items has a selling price and the selecting means includes means for comparing a selling price of one of the at least two different items with a selling price of the other item to select one item having a higher selling price if selling prices of the at least two different items are different one another.

8. A method for performing a discount service in a virtual mall which comprises a plurality of virtual shops, including steps of:
generating a purchased item data when a purchase command is input, the purchase command indicating that a purchaser buys an item at one of the plurality of shops, the purchased item data including a store code identifying one of the virtual shops at which the item is purchased, an item code identifying the item purchased and a discount item flag indicating that the purchased item is a discount item, the discount item flag being set where the purchased item is specified as a discount item by one of the plurality of shops;
discriminating whether items indicated by at least two discount item flags in a plurality of purchased item data are respectively purchased from different shops based on the purchased item data; and
executing a discount if the discriminating means determines that the items indicated by the at least two discount item flags are purchased from different shops.

9. A method according to claim 8 further including step of selecting one item from at least two different items indicated by at least two discount item flags if the at least two different items indicated by the at least two discount item flags are purchased at the same shop.

10. A method according to claim 9, wherein each item of the at least two different items has a selling price and the selecting step includes step of comparing a selling price of one of the at least two different items with a selling price of the other item to select one item having a higher selling price if prices of the at least two different items are different to one another.

11. Computer executable codes, stored in a computer readable medium, which when executed codes:
virtually creating a virtual mall including a plurality of virtual shops;
generating a purchased item data when a purchase command is input, the purchase command indicating that a purchaser buys an item at one of the plurality of shops, the purchased item data including a store code identifying one of the virtual shops at which the item is purchased, an item code identifying the item purchased and a discount item flag indicating that the purchased item is a discount item, the discount item flag being set where the purchased item is specified as a discount item by one of the plurality of shops;
discriminating whether items indicated by at least two discount item flags in a plurality of purchased item data are respectively purchased from different shops based on the purchased item data; and
executing a discount if the items indicated by the at least two discount item flags are purchased from different shops.

12. Computer executable codes according to claim 11 further selecting one item from at least two different items indicated by at least two discount item flags if the at least two different items indicated by the at least two discount item are purchased at the same shop.

13. Computer executable codes according to claim 11, wherein each item of the at least two different items has a selling price, comparing a selling price of one of the at least two different items with a selling price of the other item to select one item having a higher selling price if prices of the at least two different items are different one another.
